(19) United States
(12) Patent Application Publication
(10) Pub. No.: US 2004/0195375 A1
(43) Pub. Date: Oct. 7, 2004

(54) Systems and methods for application of tire treatment agent

(76) Inventors: Richard Koeth, Aliso Viejo, CA (US); Christine Davies, Long Beach, CA (US)

Correspondence Address: BRADLEY M GANZ, PC, P O BOX 10105, PORTLAND, OR, 97296

(21) Appl. No.: 10/758,732

(22) Filed: Jan. 15, 2004

Related U.S. Application Data
(60) Provisional application No. 60/440,592, filed on Jan. 15, 2003.

(51) Int. Cl. B05B 7/32

(52) U.S. Cl. 239/337

(57) ABSTRACT

An adjustable spray head and method of use for a directing a vaporized fluid treatment for automotive tires. The vapor dispersal pattern is adjustably selected within a defined range. The vapor comprises lubricating, cleansing, and conditioning agents and an antioxidant.

This invention claims the benefit of co-pending U.S. Provisional Application No. 60/440,592, entitled Systems and Methods for Application of Tire Treatment Agent, filed Jan. 15, 2003, the entire disclosure of which is incorporated by reference as if set forth in its entirety for all purposes.

### BACKGROUND OF THE INVENTION

This invention relates to a spray head and method of use for variable distribution of vaporized fluids. Generally, spray heads for an aerosol-type dispensing container are known, however control of the pattern of the vapor stream of vaporized fluid has been limited. Therefore, this invention relates particularly to a variably adjustable pattern of the vapor stream controlled by a user of the spray head when used in conjunction with known dispensing containers to dispense a treatment agent. More particularly, the invention relates to a user-selectable pattern of vaporized fluid for applying a treatment agent to tires.

Conventional pressurized systems of dispensing tire treatment agents have certain disadvantages, for example, they create overspray. The overspray is undesirable because it can coat parts of a vehicle that are not intended to receive the tire treatment agent. Controlling overspray is important because such areas may have just been cleaned or detailed and the tire treatment agent may detract from the cleaning or detailing. Overspray may also spread to other objects in the work area, leaving an undesirable residue on such objects. In some situations, the overspray may be harmful to surfaces adjacent to the tire. Overspray may also contain chemicals offensive to a user's senses or health.

Another problem with conventional systems is their wastefulness. Because the conventional systems are “one-size-fits-all,” the spray pattern may overspray smaller diameter tires. In the case of larger diameter tires, the spray pattern does not allow a single-pass efficient application of material.

Another problem with conventional spray container systems is their inability to have a user-selectable variable spray pattern when the container is inverted 180 degrees from vertical because the siphon dip tube opening remains at the bottom of the container with the liquid shifts to the top end. Conventional systems typically do not function sufficiently long to provide a meaningful spray when inverted. Some attempts have been made to permit inverted use of a pressurized fluid by using a 360-degree-valve system. In a 360-degree-valve system, a ball sits in a closed position when the container is used in an upright position. This causes the treatment fluid to be drawn from the bottom of the container through the siphon tube. When inverted, the conventional 360-degree valve ball opens, allowing fluid that is now resting against the valve to be drawn into the spray head. However, the conventional system cannot be used with variable spray head systems, which are not based on ball valves.

Accordingly, for one or more of the foregoing reasons, there is a significant need for improved systems for applying tire treatment agents.

### SUMMARY OF THE INVENTION

A general objective of the present invention is to provide a spray head, which will have a variably adjustable vapor stream pattern over a wide range of flow rates. In one embodiment, the system of the present invention will dispense a variably adjustablevapor stream pattern at a prescribed flow rate.

Another objective of the present invention is to provide a user selectable pattern of the vapor stream in order to tailor the amount of vapor according to the application. For example, low profile tires, as found on a performance vehicle, would require a different effluent pattern than high profile tires, as found on a sport utility vehicle, for example.

Another objective of the present invention is to provide a spray head that is easy to use and one that produces less waste and reduces costly clean up.

Without an appropriate treatment agent, tires may oxidize, fade in color, appear less black, and crack at an undesirable rate. Therefore, this invention provides a spray head and method of applying a vaporized fluid to tires to prevent fading, cracking, premature aging and retard oxygenation.

Another objective of the invention is to provide a spray head and method of use that prevents cracking, browning, premature aging and retards oxygenation of any rubber or synthetic tire. A further objective of the invention is to provide a spray head and method of use that is easy to use and results in tires that look blacker and last longer than available in the prior art.

Another objective of the invention is a method of making a pressurized dispensing container and adjustable spray head. This includes providing a dispensing container adapted for receiving pressurized fluid. Filling the container with a treatment agent and a propellant. Providing an adjustable spray head that includes a stem and a nozzle. Inserting one end of the stem into the dispensing container and attaching the opposite end of the stem to the spray head. Adapting the nozzle to provide a particular spray pattern based on a user-selectable range of adjustment, of which one pattern is a broad and flat spray pattern. The final step may be assembling the spray head to the container.

These and other embodiments are described in more detail in the following detailed description and the figures.

### BRIEF DESCRIPTION OF THE DRAWINGS

FIG. 1 is a top view of a possible spray head according to the present invention.

FIG. 2 is a representation of one possible method of use according to the present invention as applied to a low profile tire.

FIG. 2A is a top view of the spray head and container used in the method of of FIG. 2.

FIG. 3 is a representation of another method of use according to the present invention as applied to a high profile tire.

FIG. 3A is a top view of the spray head and container used in the method of FIG. 3.

FIG. 4 is a side view of a dispensing container and spray head for use in the present invention.

FIG. 5 is a partial perspective view of the top of a container with a spray head and directional indicating means of the present invention.

FIG. 6 is a partial cross-sectional view of a side of the spray head in exploded format according to one possible embodiment of the present invention.

FIG. 7 is a cross-sectional side view of the spray head of FIG. 6 as assembled on a dispensing container.

FIG. 8 is a side cross-sectional view of an alternate embodiment of the spray head of the present invention.

FIG. 9 shows a front view one embodiment of a spray head having a nozzle with a vertical slot according to the present invention.

FIG. 10 shows a back view of the spray head of FIG. 9.

FIG. 11 shows a side view of a spray head and tube according to the present invention.

### DETAILED DESCRIPTION OF THE INVENTION

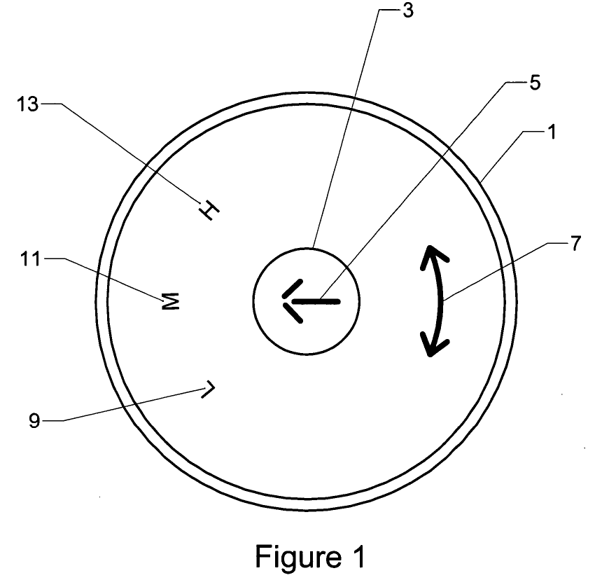

An improved system for dispensing a tire treatment agent consists of a tire treatment agent contained in a pressurized dispensing container 1 having an adjustable spray head 3 for controlling the pattern of a vaporized fluid form of the agent being dispensed. In one possible example, a dispensing container is assembled to a spray head 3 with an indicator 5 showing the relative direction of a selectably releasable vaporized fluid stream. The stream of vaporized fluid has a user-selectable pattern. In one embodiment, the letter “L” 9 may be used to indicate the stream pattern for a low profile tire. Other symbols may be used to designate other selectable patterns. For example, as shown in FIG. 1 the letter “M” 11 may be used to represent a mid-level pattern and the letter “H” 13 may be used to indicate the pattern for a high profile tire. Also depicted is an adjustment arrow 7 indicating the relative motion of the spray head 3 in relation to the container 1.

Between each discrete setting, indicated by “L” 9, “M” 11 and “H” 13, there is a variable range of finer control. This affords a seamlessly variable and controllable vapor stream pattern. While this disclosure references visual scaling means of L, M, H, it is understood that many other combinations of letters, numbers, characters or combinations may be used to represent the range of adjustment of the spray head. Thus, a user may rotate the spray head within a predetermined range of adjustment 7 and thereby control the pattern of the vapor stream 15.

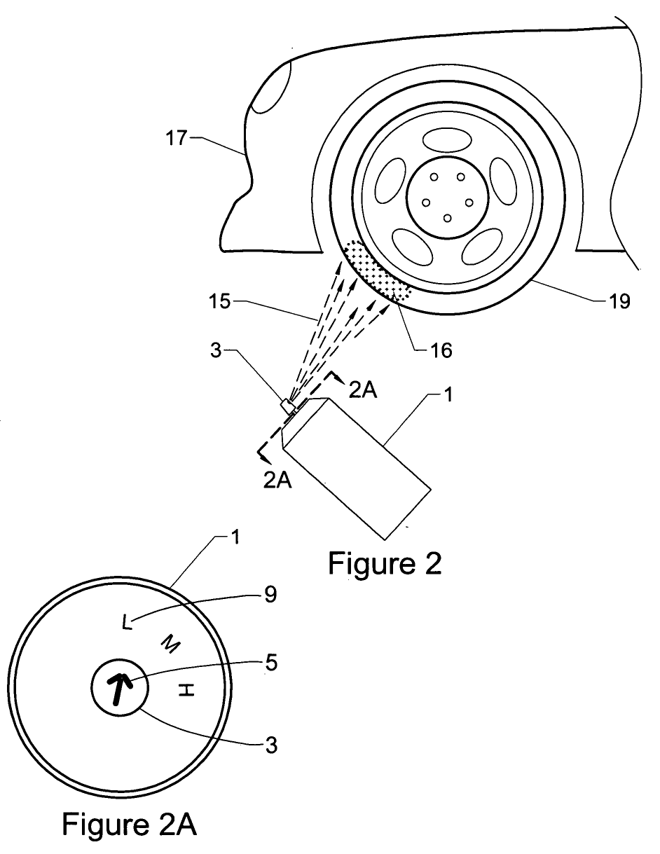

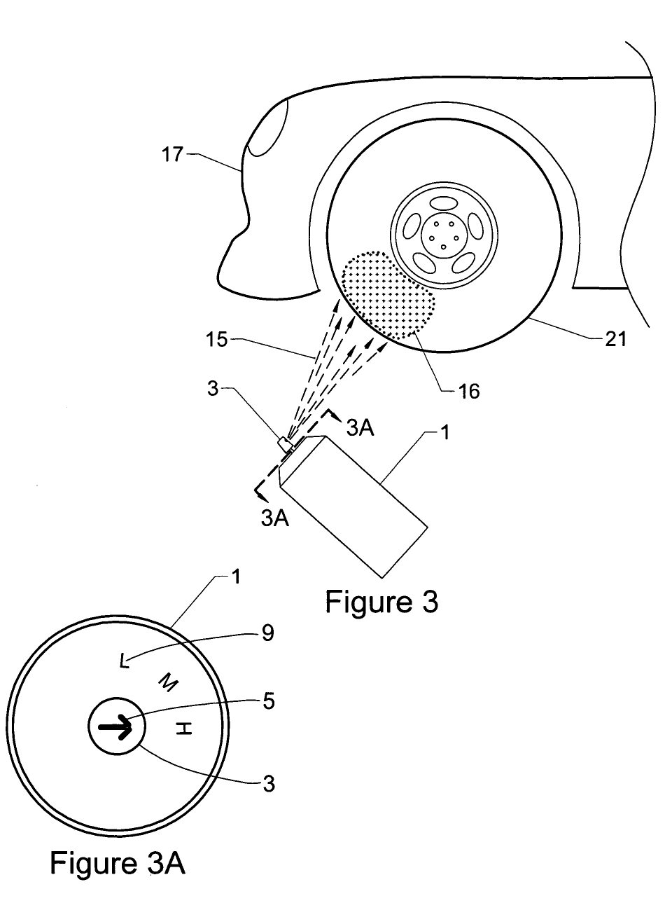

FIGS. 2 and 3 show two different spray patterns 16 of the vapor stream 15. While the resultant shape of the pattern in FIGS. 2 and 3 is generally similar, the size differs, resulting in, for example, two different patterns. A spray pattern may have a particular shape, size, and/or amount of fluid. Thus, altering any combination of these factors results in a different spray pattern.

In one embodiment, the system of the present invention will dispense a variably-adjustable vapor stream pattern at a prescribed flow rate range. In a possible embodiment, the flow rate of the fluid stream would vary between about ½ gram per second to about 4 grams per second, for example. In a possible embodiment the treatment fluid may have a generally constant pressure of about 65 psi to about 75 psi, for example.

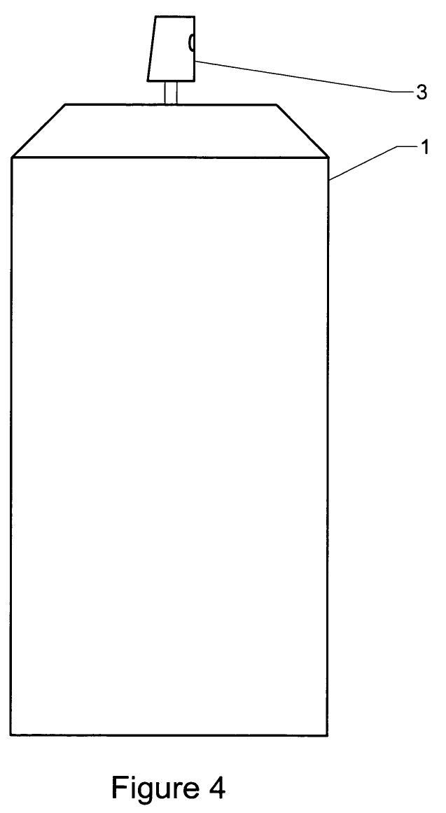

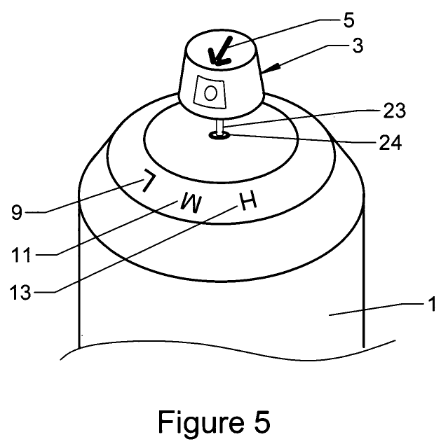

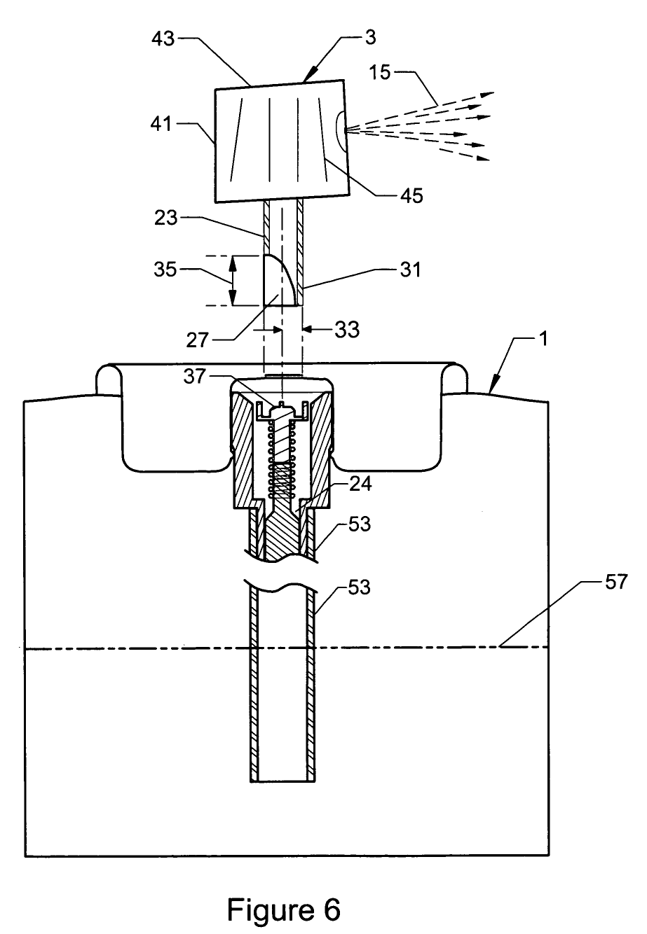

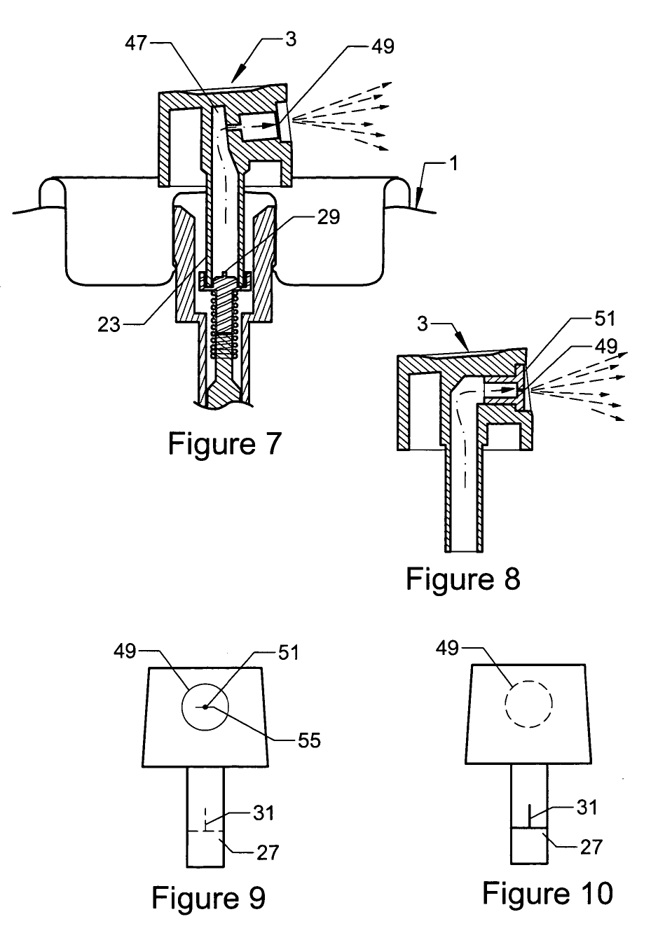

FIGS. 4 and 6-9 depict a side view of the spray head 3 in relation to the dispensing container 1. The spray head 3 may have a generally cylindrical body 41 with a top 43, which may be generally perpendicular to the body 41. The top 43 may further include an indicating means, such as an arrowhead 5. At an end opposite the top 43, the body 41 has a stem 23 in fluid communication with the dispensing container 1. For example, FIG. 6 shows a fluid fill line 57, which represents a possible container 1 with a treatment fluid in communication with siphoning tube 53.

The spray head may have a grooved surface 45 on the body 41 to facilitate directional manipulation of the spray head 3 by a user. Relative to the dispensing container 1, the spray head 3 may have a rotary range of motion 7 in one plane. Selection of the range of motion may be facilitated by the viewing a relational scale having “L” 9 to indicate a relatively small release of the volume of the vapor stream, and having a “M” 11 and “H” 13 to further indicate increasing volumes of the vapor stream, for example.

In a possible embodiment, the pivot point for this rotary range of motion 7 is an axis collinear with the longitudinal axis of the stem 23. The stem 23 may be a hollow conduit member having an intake end 27 oppositely spaced from a discharge end 29. In a typical embodiment, the intake end 27 has a vertical notch 31 of a predetermined arc length 33 and height 35. The stem 23, being in fluid communication with the dispensing container 1 engages a release 37 located in the orifice 24.

The release 37 cooperates with the vertical notch 31 whereby a portion of the vertical notch 31 partially blocks the opening defined by the release 37 in relation to the range of adjustment 7. In a possible embodiment, when the relational scale indicates “L” 9, a small portion of the vertical notch overlaps the release 37 thereby restricting the flow of the vapor stream 15. This selection may result in a dispersion pattern 16, as shown in FIG. 2, for example. Correspondingly, if the spray head 3 is directed toward “H” 13 on the relational scale then a very large portion of the notch 31 would overlap the release 37 whereby a relatively greater volume of the vapor stream would be permitted to flow into the spray head 3 by means of the stem 23. This may result in the dispersion pattern 16 of FIG. 3, for example.

The vaporized stream 15 flows from the dispensing container 1 through the release 37 into the intake end 27 and being restricted to some extent by the vertical notch 31. Due to the pressure of the fluid in the container 1, the rate and pattern of flow changes through the discharge end 29 of the stem 23 and into the head body 41. The fluid mixes with ambient atmospheric gases in the chamber 47 and expands from the nozzle 49 as it is directed to a user-targeted application. In one embodiment, the user-targeted application may be a tire, such as a low profile performance tire or a high profile tire.

FIG. 2 shows the combination of the spray head 3 on a known dispensing container 1 directing a stream of the agent toward An effluent liquid-gas colloid stream 15 of the agent is directed toward the low profile tire 19 on vehicle 17.

FIG. 2A shows the top view of the container 1 and spray head 3. The spray head 3 has an indicator 5. Here, the indicator is directed toward the letter “L” 9, indicating the vapor spray pattern appropriate for low profile tires 19.

FIGS. 3 and 3A show another method of use of the present invention. A vehicle 17, such as a sports utility vehicle, is depicted with a high profile tire 21. The dispensing container 1 with spray head 3 is directed to the tire 21. The effluent stream 15 is directed in a pattern for high profile tires 21. Referring now specifically to FIG. 3A, a-top view of the dispensing container 1 and spray head 3 is shown. The spray head 3 has an indicator 5 directed at the letter “H” 13, indicating the selected vapor pattern.

As shown in the figures, the spray head 3 may be used in combination with known dispensing containers 1. A known attaching means connects an effluent stem 23 of the spray head 3 to an orifice 24 on the container 1. The spray head 3 may also have known valve means to control the volume of the vapor stream 15 and known throttling means whereby the pattern of the vapor stream 15 may be selectably adjusted by a user within a range of adjustment 7. The spray head 3 also incorporates known aerating means whereby ambient atmosphere is introduced to the vapor stream in the spray head 3. The spray head 3 further comprises a means for depressing the spray head to selectively release the agent.

In a possible embodiment the tire treatment agent comprises one or more of a lubricating agent, such as silicone, a cleaning agent, an antioxidant and a conditioner whereby a provided automobile tire, upon application of the vapor by means of the spray head 3, will appear blacker, last longer, reduce cracking or browning. Any number of known aerosol propellants may be used to pressurize and dispense the tire treatment agent from a container. In one embodiment the agent includes a propellant that also acts as a solvent. The agent may also include a lubricant to prolong the useful life of a tire by maintaining a pliant, non-brittle surface. A conditioner may be included with the agent to enhance the appearance of the tire. In combination, or alone, the agents for lubricating, conditioning and cleaning, and the antioxidant are used to enhance the aesthetic appearance, reduce cracking, extend the life of the surface, reduce fading or browning, and generally maintain the color of the tire.

In a representative embodiment the treatment may comprise a silicone based formulation, such as a formula for a tire treatment comprising dimethyl polysiloxane, dimethyl ketone, 2-proponone, aliphatic petroleum distillates, anti-oxidant additives and selected fragrant oils, as are well known in the art. Generally, any other known tire treatment agent may be supplied in container 1. In a possible embodiment, the treatment agent may contain an additive that acts as an anti-degradation barrier from ground level ozone. In one embodiment, this anti-degradation component may be Durazon 37 available from Crompton Corporation at 199 Benson Road, Middlebury, Conn. 06749.

A spray head 3, such as a model number NG166-110-197-1620 black actuator and a variable valve, model number V810118, reservoir siphon (dip) tube of about 8 ⅝″ length with an inside diameter of about ⅝″ and outside diameter of about ⅞″, all available from Newman-Green, Inc. at 57 Interstate Road, Addison, Ill. 60101 USA may be used atop a tin plate aerosol can (for example, model number 211/214×804, available from Crown Cork & Seal Company, Inc., One Crown Way, Philadelphia, Pa. 19154-4599 USA) in combination with a scaling means, such as a relational guide containing L, M, and H to represent low profile, medium and high profile tires, respectively. Other necessary components are widely understood in the art. In this configuration, one embodiment of the present invention may be inverted and maintain full functionality for about 8 seconds, including maintaining a user-selectable and variable spray pattern. Accordingly, the siphon tube 53 may act as a reservoir for the spray head 3 when the container 1 is inverted 180 degrees from vertical.

In another embodiment shown in FIGS. 8-9, a spray head may have a modified stem 23. The stem may have a longer length for improved siphoning, as would be understood in the art.

Additionally, the nozzle 49 may be configured in various ways to maximize the efficiency of the spray pattern. For example, shown in FIG. 9, the nozzle 49 may have an insert 51 with a vertical slot 55. This configuration may produce a generally broad and flat effluent stream pattern. The amount of fluid may be controlled by rotating the spray head 3, as previously described. Thus, in one embodiment a variable amount of tire treatment agent may be applied according to the targeted tire in a resulting pattern that is broad and flat.

Other possible embodiments may include varied-shaped inserts (not shown) in the nozzle 49. The inserts may be selected and attached to the nozzle according to the desired stream pattern.

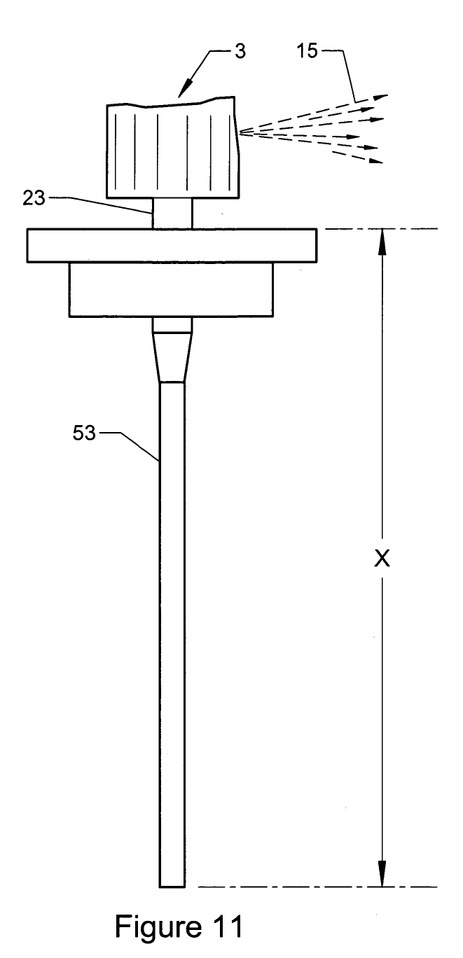

FIG. 10 shows a possible arrangement of a spray head 3 and a siphoning tube 53 as may be typically used in a known dispenser container. The length of the siphoning tube 53 may be altered as required for appropriate siphoning of a fluid in any given dispenser. Also, the tube 53 may act as a reservoir for the fluid when the container 1 is used in an inverted position. Other reservoir mechanisms may be incorporated to allow full functioning of the variable spray pattern when the system is used in an inverted position. A siphon dip tube 53 with a reservoir capacity is a tube that has more capacity than conventional systems. Conventional systems typically provide only up to about one second of inverted spray capability. This relatively short spray duration does not enable a user to provide meaningful treatment over target surfaces. A minimum of at least about three seconds of inverted spray is considered by the inventors as a minimum inverted spray duration for significant or meaningful treatment of a target surface. The reservoir for meaningful spray may be provided by increasing the size, volume, and or shape of the siphon dip tube, or by attaching a volumetric space to the siphon dip tube, which is in fluid communication with it. In a possible embodiment, the reservoir, for example, siphon tube 53, provides at least about three seconds of flow to target surface via the spray head 3. In a more desirable embodiment, the reservoir provides at least about five seconds of flow of the treatment agent to the target surface. In yet a more desirable embodiment, the reservoir may provide at least about eight seconds of flow to the target surface. As shown in FIG. 11, a possible embodiment of the present invention shows a reservoir comprising siphon tube 53 that is of a predetermined volume to provide greater than about eight seconds of flow to a target surface.

While representative embodiments of the present invention discuss a container with tire treatment agent, the reservoir of the present invention is equally suited to any fluid, and is not restricted only to tire treatment agents. Other applications may include containers with cleaning agents, lubrication agents, or adhesive agents, for example.

Another way of expressing the predetermined volume of the reservoir is by the product of the desired flow rate times the desired minimum duration for the container to provide a generally constant flow when inverted:

MAX FLOW RATE×MAXIMUM INVERTED DURATION=MINIMUM VOLUME OF RESERVOIR. Replenishing the reservoir by reverting the container will extend the ability of the system to function in an inverted position. Accordingly, the inverted duration may be extended until the contents of the container are depleted. The practical limit of the siphon tube is that it must draw fluid from the bottom of the container. It is understood in the art that the length of the siphon tube may be maximized to reduce inaccessible fluid (due to a too short tube), without preventing desired siphoning of the fluid. It is also understood that the inverted reservoir volume may be maximized, which would result in longer inverted spray duration for a given flow rate. In one possible embodiment, the maximum flow rate is about 4 grams per second and the minimum inverted operation duration is at least about 8 seconds. This requires a minimum volume of the reservoir to be about 32 grams. As shown in FIG. 11, the reservoir is siphon tube 53, which has a volume of at least 40 grams for a container that has a capacity of about 280 gram of tire treatment agent.

Another possible embodiment of the present invention is the combination of known dispensing containers with a variable-adjustable head to dispense a formulation of tire treatment agent. It is desirable to have a variable range to compensate for decreasing volume. While pressure may remain relatively constant, the decrease in volume may necessitate adjustment of the spray head to obtain the desired spay pattern. It will be understood that the present invention may have other applications beyond a tire treatment agent.

As understood in the art, many different attaching means may be utilized for fixing the spray head to the dispensing container. In one embodiment, the attaching means may include a slip fit of the stem of the spray head to a cooperating feature on the dispensing container.

The foregoing embodiments and features are for illustrative purposes and are not intended to be limiting, persons skilled in the art being capable of appreciating other embodiments from the scope and spirit of the foregoing teachings.

What is claimed:

1. A system for dispensing a tire treatment agent comprising a dispensing container having a tire treatment agent, a propellant and a spray head, the spray head being selectably adjustable to provide a plurality of spray patterns.

2. The spray head of claim 1 further comprising:
a stem in fluid communications with the container;
a nozzle in fluid communication with the stem, the nozzle comprising
a valve means, a throttling means, an aerating means, and a directional means whereby the vaporized fluid is selectively directed;
the spray head further comprising a depressing means in communication with the stem whereby the stem is selectively engaged with the dispensing container causing controlled escapement of the agent into the spray head.

3. The nozzle of claim 2 further comprising an insert that produces a generally flat and broad spray pattern.

4. The system of claim 1 further comprising a reservoir in fluid communication with the spray head, the reservoir having a capacity to provide the spray head with a predetermined volume of the agent when the system is inverted to provide at least about three seconds of inverted spray at a flow rate about the same as an upright container.

5. The reservoir of claim 4 comprising a siphon tube having a predetermined volume to provide at least about five seconds of inverted spray at a flow rate about the same as an upright container.

6. The reservoir of claim 4 comprising a siphon tube having a predetermined volume to provide at least about eight seconds of inverted spray at a flow rate about the same as an upright container.

7. The spray head of claim 1 further comprising a nozzle having an insert that produces a flat, broad spray pattern.

8. The spray head of claim 1 further comprising:
a spray body;
a stem in fluid communication with the spray body at one end and with the dispensing container at an opposite end;
the stem comprising a hollow conduit having an intake end having a notch whereby the notch cooperates with the dispensing container to selectively release predetermined volumes of the vaporized fluid.

9. The spray head of claim 8 further comprising an indicating means for setting a spay pattern.

10. The spray head of claim 9 wherein the indicating means comprises an arrowhead and at least one symbol on the container that cooperating with the arrowhead to indicate the spray pattern.

11. The treatment agent of claim 1 further comprising at least one of the following: a cleaning agent, a lubricating agent, an antioxidant and a conditioning agent.

12. The tire treatment agent of claim 11 wherein the lubricating agent is silicone.

13. A variable adjustable spray head for a dispensing container having an orifice and a release, the spray head comprising:
a stem and a notch;
a nozzle in fluid communication with the stem, the nozzle directing a volume of fluid from the container;
and the notch being rotatable in relation to and cooperating with the orifice to provide an adjustable volume of flow from the container to the nozzle.

14. The variable adjustable spray head of claim 13 wherein the stem further comprises:
an intake end and an oppositely spaced dispensing end, the dispensing end being in fluid communication with the nozzle;
the intake end comprising a vertical notch having an arc length and a height, whereby the intake end is in fluid communication with the container by means of the orifice and the release;
the notch further communicating with the release whereby the stem rotation causes a variable blocking of the release.

15. The spray head of claim 14 wherein the nozzle further comprises an insert in fluid communication with the stem, the insert providing a flat and broad effluent spray pattern.

16. A system for dispensing a tire treatment agent comprising a dispensing container having a tire treatment agent, and a spray head, the spray head being selectably adjustable to provide a generally flat and broad spray pattern.

17. A system for dispensing a tire treatment agent comprising:
a dispensing container;
a propellant;
a spray head, the spray head being selectably adjustable to provide a plurality of spray patterns; and
a reservoir in fluid communication with the spray head, the reservoir providing a portion of the agent to the spray head when the system is inverted.

18. A method of making a pressurized dispensing container and adjustable spray head comprising:
providing a dispensing container with an adjustable spray pattern;
providing a spray head; and
filling the dispensing container with a tire treatment agent and a propellant.

19. The method of claim 18 further comprising the steps of:
providing a stem;
inserting one end of the stem inside the dispensing container;
providing a nozzle assembly; and
providing indicating means for setting a spray pattern.

20. The method of claim 19 further comprising:
providing an insert to be placed in the nozzle assembly for dispensing a broad and flat spray pattern.

21. The method of claim 19 further comprising:
providing an indicating means comprising at least one of the following: letters, numbers, symbols, and characters to represent the range of the effluent spray pattern.

22. The method of claim 19 further comprising:
providing a reservoir of a predetermined volume that permits at least about three seconds of inverted use at a flow rate about the same as an upright container.

23. The method of claim 19 further comprising:
providing a reservoir of a predetermined volume that permits at least about eight seconds of inverted use at a flow rate about the same as an upright container.

24. The method of claim 18 further comprising:
providing a reservoir of a predetermined volume that permits at least about three seconds of inverted use at a flow rate about the same as an upright container.

25. The method of claim 18 further comprising:
providing a reservoir of a predetermined volume that permits at least about five seconds of inverted use at a flow rate about the same as an upright container.

26. The method of claim 18 further comprising:
providing a reservoir of a predetermined volume that permits at least about eight seconds of inverted use at a flow rate about the same as an upright container.

27. The method of claim 18 further comprising:
providing a spay head for dispensing a generally broad a flat spray pattern.

28. A method of treating a tire comprising the steps of:
providing a pressurized dispensing container having an adjustable spray head, the spray head having an adjustable range of spray patterns, the container including a tire treatment agent and the spray head comprising a stem and a nozzle;
selecting a desired spray pattern on the adjustable spray head; and
applying the agent on the tire.

29. The method of claim 28 further comprising:
providing an insert for the nozzle, the insert causing the agent to be dispersed in a broad and flat stream pattern.

30. The method of claim 28 further comprising:
providing a reservoir of a predetermined volume for at least about three seconds of inverted use at a flow rate about the same as an upright container.

31. A system for dispensing a treatment agent comprising:
a dispensing container;
a spray head, the spray head being selectably adjustable to provide a plurality of spray patterns; and
a reservoir in fluid communication with the spray head, the reservoir providing a portion of the agent to the spray head for inverted use of the system at a flow rate about the same as an upright container.

32. The spray head of claim 31 further comprising:
a nozzle in fluid communication with the spray head, the nozzle comprising a valve means, a throttling means, an aerating means, and a directional means whereby the vaporized fluid is selectively directed;
the spray head further comprising a depressing means in communication with the container whereby the spray head is selectively engaged with the container causing controlled escapement of the agent into the spray head.

33. The nozzle of claim 32 further comprising an insert that produces a generally flat and broad spray pattern.

34. The system of claim 31 wherein the reservoir comprises a siphon tube in fluid communication with the spray head, the reservoir having a capacity to provide the spray head with a predetermined volume of the agent when the system is inverted to provide at least about three seconds of inverted spray.

35. The reservoir of claim 31 comprising a siphon tube having a predetermined volume to provide at least about five seconds of inverted spray.

36. The system of claim 31 further comprising a propellant.

37. A system for dispensing a treatment agent comprising:
a dispensing container;
a propellant;
a spray head, the spray head being selectably adjustable to provide a plurality of spray patterns, at least one of which is a generally flat and broad spray pattern; and
a reservoir in fluid communication with the spray head, the reservoir providing a portion of the agent to the spray head for inverted use of the system for at least about three seconds at a flow rate about the same as an upright container.
